(19) United States
(12) Patent Application Publication
(10) Pub. No.: US 2009/0187294 A1
(43) Pub. Date: Jul. 23, 2009

(54) System and Method for Train Awakening

(75) Inventor: Demetri James, Flushing, NY (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/356,373

(22) Filed: Jan. 20, 2009

Related U.S. Application Data
(60) Provisional application No. 61/021,851, filed on Jan. 17, 2008.

(51) Int. Cl. G05D 1/00

(52) U.S. Cl. 701/19

(57) ABSTRACT

A method and system for vitally determining initial vehicle location on a guideway when the vehicle is awakened is disclosed.

### STATEMENT OF RELATED CASES

This case claims priority of U.S. Provisional Patent Application Ser. No. 61/021,851, which was filed on Jan. 17, 2008 and is incorporated by reference herein.

### FILED OF THE INVENTION

The present invention relates to railways in general, and, more particularly, to vehicle awakening.

### BACKGROUND OF THE INVENTION

Vehicles that run on guideways under the control of a vital traffic control system may require guideway databases as part of their system implementation. These databases generally become a vital component of the system and provide the physical location of the guideway path as well as the location of features (e.g., switches, etc) on the guideway.

When a vehicle is “awakened” (i.e., initialized) on the guideway from an unconfirmed position, its position must be confirmed at the traffic control center before the vehicle can proceed with the full authority of the traffic control system. Normally this process includes an operator input; however, this procedure alone does not constitute a vital confirmation of initial position.

If it is necessary for the vehicle to move over a segment of the guideway before it can vitally confirm its location thereon, then the performance and safety of traffic operations on the guideway could be diminished.

### SUMMARY OF THE INVENTION

The present invention provides a system and method for enabling a vehicle (e.g., train, etc.) to perform a vital confirmation of its location on awakening or annunciate a failure to do so. If vital confirmation is not achieved, the vehicle proceeds under less than full traffic control authority until sufficient data has been acquired to confirm location.

In accordance with the illustrative embodiment, the vehicle determines its initial location via sensors using an onboard location determining system. This initial determination of location does not rely on a guideway database. Information from ancillary systems, such as track circuits, etc., and/or operator input, is used to corroborate the initial location estimate.

A vital, pre-determined guideway database (“operational database”) is examined to determine if more than one guideway path lies within the confidence threshold established for confirmation of initial position and/or heading. Vital confirmation of the initial startup location is obtained if a unique segment of guideway path lies within the threshold.

If, however, multiple paths exist, location cannot be confirmed. In such a situation, the vehicle proceeds under less than full authority and a trajectory of sensor-derived position is generated to create a “guideway database.” The trajectory is analyzed to develop a signature that can be used to confirm location on the network as defined by the operational guideway database.

### BRIEF DESCRIPTION OF THE DRAWINGS

FIG. 1 depicts a block diagram of a system for confirming vehicle location on awakening on a guideway in accordance with the illustrative embodiment of the present invention.

FIG. 2 depicts a flow diagram of a method for confirming vehicle location on awakening on a guideway in accordance with the illustrative embodiment of the present invention.

FIG. 3 depicts an application of the method in accordance with an embodiment of the invention wherein a unique segment of guideway is within the confidence interval of a sensor-derived estimate of initial location.

FIG. 4 depicts an application of the method in accordance with an embodiment of the invention wherein multiple segments of guideway are within the confidence interval of the sensor-derived estimate of initial location.

FIG. 5 depicts an application of the method in accordance with an embodiment of the invention wherein multiple segments of guideway are within the confidence interval of the sensor-derived estimates of location and where a trajectory “signature analysis” is used to confirm vehicle location.

### DETAILED DESCRIPTION

The following terms are defined for use in this disclosure and the appended claims:
“Vital” means that a function must be done correctly, or the failure to do so must result in a safe state. Vital is synonymous with “safety-critical.” A safety-critical system is defined when at least one identified hazard can lead directly to a mishap (accident). Standard 1483 (http://shop.ieee.org/ieeestore/) defines a safety-critical system as one where the correct performance of the system is critical to the safety, and the incorrect performance (or failure to perform the function) may result in an unacceptable hazard. According to most standards, hazards that have risk ratings of “Unacceptable” or “Undesirable” must be mitigated (i.e., reduce the risk, which is generally done by decreasing the frequency of occurrence) through system and equipment design. In order to do this, all of the functions that are necessary to implement the system must be identified. Functions that have to be implemented so that they are both (1) performed and (2) performed correctly are implemented fail-safely and are identified as “vital” functions. The fail-safely implementation means that all credible failures that could occur are examined and the occurrence of any one of them (or combination of failures in the event that the first failure is not self-evident) maintains the system in a safe state. That can be done either by forcing the system to a stop (or other safe state such as a less-permissive signal) or by transferring control to a secondary system, such as a redundant computer.

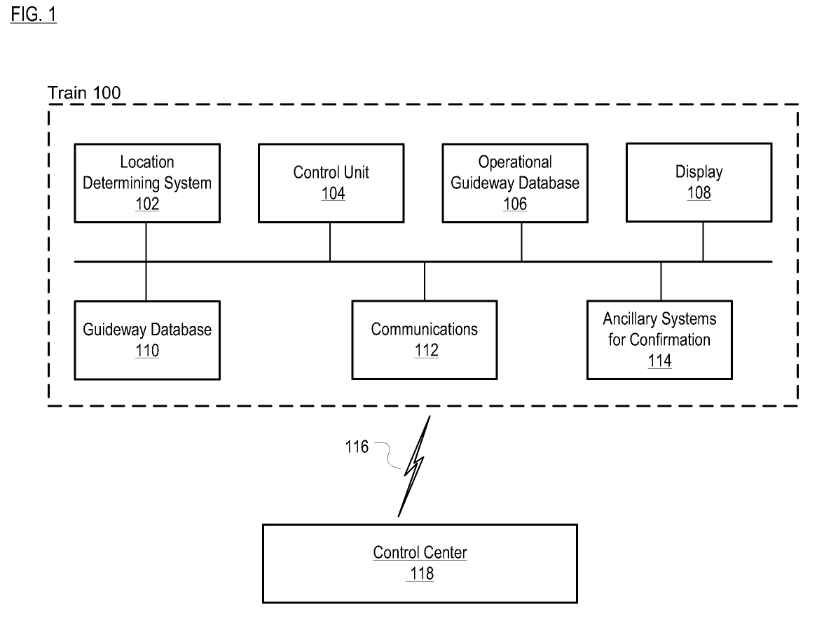

FIG. 1 depicts a block diagram of a system for confirming vehicle location on awakening on a guideway, in accordance with the illustrative embodiment of the present invention.

As depicted in FIG. 1, the system includes a plurality of sub-components that are located on a vehicle, such as train 100. In some other cases, a “sub-component” is a database, which is stored in a computer-accessible memory.

The sub-systems include location-determining system 102, a control unit 104, operational guideway database 106, display 108, guideway database 110, communications system 112, and ancillary systems 114 for location confirmation.

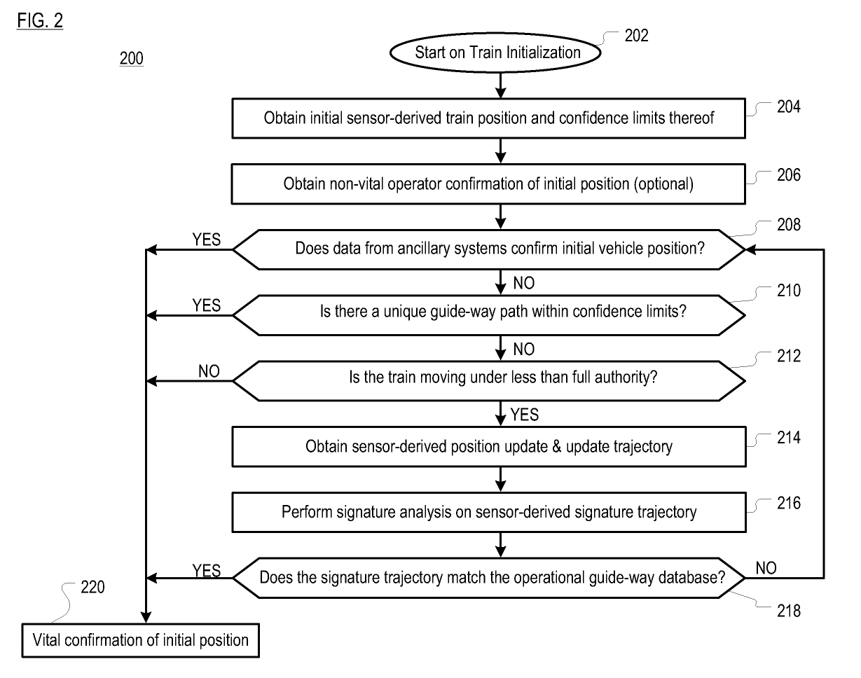

Location determining system 102 is typically satellite-based (e.g., GPS) and, in some embodiments, will be augmented via inertial sensors, such as accelerometers, gyroscopes, and the like, to provide additional outputs such as speed and/or heading. Control unit 104 is a processor running software that is capable of carrying out the tasks depicted in FIGS. 2-5. Operational Guideway Database 106 stores vital, pre-determined track information including the absolute and relative position and attitude (i.e., heading, grade, and super-elevation) of tracks and track transitions such as, for example, switches and turnouts.

Display 108 is a CRT or other type of display device for indicating authorities, warnings, etc., for the crew of the train. Guideway database 110, as distinguished from operational guideway database 106, is a database of the vehicle's trajectory as determined by onboard location determining system 102. Communications system 112 is a conventional wireless communications system by which the train communicates with a controlling entity (e.g., control center 118), among any other entities.

Ancillary systems 114 for location confirmation include trackside infrastructure, such as track circuits/interlockings, and RFI tag reader systems. Information from ancillary systems (e.g., trackside infrastructure such as track circuits/interlockings and RFI tag reader systems) is advantageously used to corroborate the location estimates from the location determining system. In some embodiments, corroboration (non-vital confirmation) is provided by the vehicle operator.

In accordance with the illustrative embodiment, the train's location determining system computes a solution for the train location via two methods. The first location solution is a “sensor-derived location” that is based on location determining system 102 without reference to operational guideway database 106. In some embodiments, the sensor-derived location also provides additional outputs such as speed and heading.

The second location solution is an “operational vehicle location.” This second location solution is derived using operational guideway database 106 wherein the vehicle is constrained to lie on a guideway path. In other words, the guideway database is examined to see if one guideway path lies within the confidence threshold established for confirmation of the initial location.

FIG. 2 depicts method 200 for enabling a train to perform a vital confirmation of its location on awakening, or annunciate a failure to do so.

As per operation 202 of method 200, the method begins as the train awakens. In accordance with operation 204, an initial sensor-derived train position and the confidence interval thereof, are obtained. Optional operation 206 includes non-vital confirmation by the train operator of initial position.

The system determines whether data from ancillary systems (e.g., ancillary system 114 of FIG. 1) confirm initial vehicle position, as per operation 208. If so, this is considered vital confirmation of the initial position, as per operation 220. This confirmation is transmitted to control center 118 and the train proceeds under its full movement authority.

If there is no confirmation from ancillary systems, the system determines whether there is a unique guideway path (i.e., track) in operational guideway database 106 within the confidence interval of the initial sensor-derived train position, in accordance with operation 210.

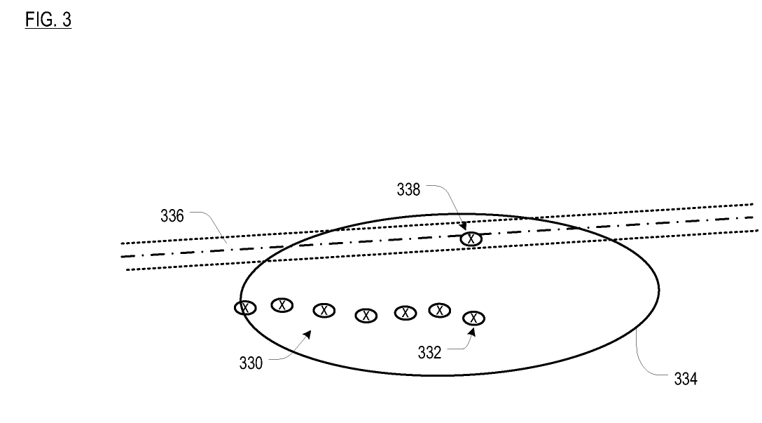

If a unique guideway path is identified, then vital confirmation of the initial startup position is considered to be accomplished, as per operation 220. This confirmation is transmitted to control center 118 and the train proceeds under its full movement authority. In some alternative embodiments, filter-error residuals within the operational vehicle position solution algorithm are used to identify acceptable error limits to establish vital confirmation of the initial vehicle location. In conjunction with the present disclosure, those skilled in the art will know how to use filter-error residuals to identify acceptable error limits. Vital confirmation based on the identification of a unique guideway path in the confidence interval is discussed further in conjunction with FIG. 3.

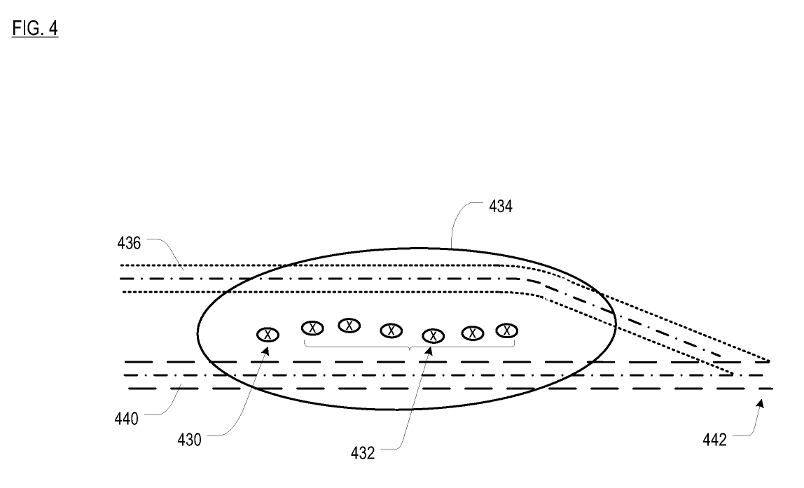

If the confidence interval of the sensor-derived position contains more than one guideway path, that is, if there is no unique guideway path, then the initial vehicle location cannot be confirmed. In absence of any other reason for unrestricted movement authority, the train is restricted to move under less than full authority in the control center's traffic control system, as per operation 212. The situation in which multiple guideway paths are within the confidence interval is discussed further in conjunction with FIG. 4.

In accordance with operation 214, an update of sensor-derived position and trajectory, etc., is obtained. As the vehicle proceeds (under less than full authority), it will either reach an area where the confidence interval contains a unique guideway segment, or, there will be multiple guideway segments but only one of which has a “signature” that satisfies a vital confirmation requirement for the initial location. In some embodiments, the signature is based on the heading output (trajectory) of location determining system 102. In some other embodiments, signatures are based on heading rate or curvature.

In accordance with operation 216 of the illustrative embodiment, control unit 104 performs a signature analysis on the sensor-derived trajectory (or other signature-suitable) data. In conjunction with the present disclosure, those skilled in the art will be able to develop an algorithm, as embodied in software, to perform the signature analysis.

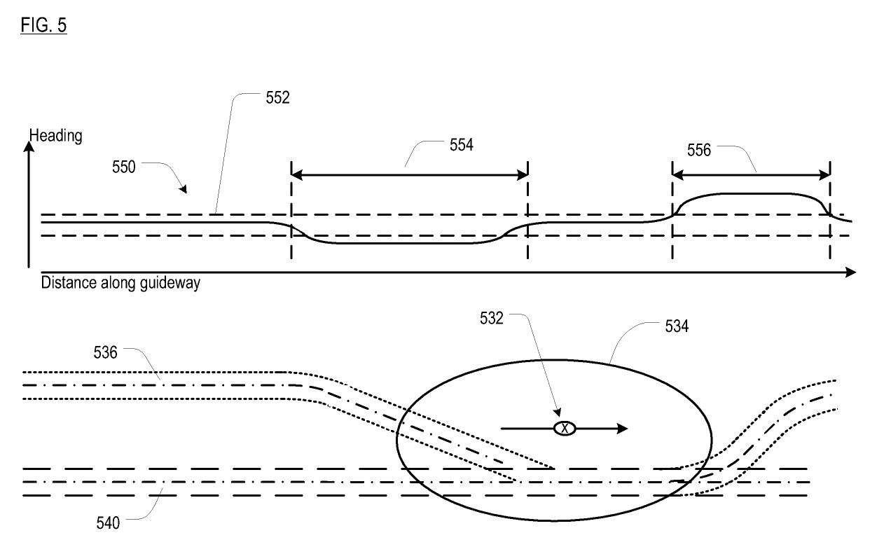

In operation 218, control unit 114 determines if the sensor-derived signature matches the corresponding parameter of operational guideway database 106. If so, then vital confirmation of the initial startup position is considered to be accomplished, as per operation 220. This confirmation is transmitted to control center 118 and the train proceeds under its full movement authority. The situation in which signature analysis is used to resolve track is discussed further in conjunction with FIG. 5.

If the signature cannot be matched, the processing loops back to operation 208 wherein a determination is made as to whether the latest data from ancillary systems confirm the latest estimate of vehicle position, etc.

FIG. 3 depicts the presence of a unique guideway path in the confidence interval of sensor-derived position. Note that this Figure, as well as FIGS. 4 and 5, are not to scale. The divergence between sensor-derived positions and operational-vehicle positions are exaggerated for clarity.

With reference to FIG. 3, upon awakening, a train provides an initial estimate 332 of its location (via its location determining system 102). Earlier position estimates 330 are depicted in FIG. 3, as well. Confidence interval 334 for the position estimate are determined in known fashion. In some embodiments, earlier position estimates 330 are used to establish the confidence interval. Reference to operational guideway database 106 reveals that guideway segment 336 is the only path within confidence interval 334. In other words, guideway segment 336 is unique. A vital confirmation of the initial start-up position is considered to be accomplished. The actual start-up location of the train is therefore at position 338, since the train must be on the vital, pre-determined guideway.

FIG. 4 depicts a situation in which multiple guideway paths are within the confidence limits of the sensor-derived position. In this scenario, there is no unique pathway within the confidence interval of the initial estimate of position when the train awakens (position 430). As depicted in FIG. 4, both guideway 436 and guideway 440 are within the confidence interval of sensor-derived position. Repeated sensor-derived position estimates are obtained at 432, but no unique path is identified.

As the train proceeds (under less than full authority), it will either reach an area 442 where the confidence interval contains a unique guideway segment (tracks 436 and 440 merge). At that point, a vital confirmation of location can be made and movement restrictions can be lifted.

FIG. 5 depicts the use of a signature to resolve to track. FIG. 5 depicts two guideways 536 and 540. Sensor-derived location of the train is depicted at location 532 with confidence interval 534. The heading signature derived from location determining system 102 is indicated at 550, with confidence interval 552.

The heading changes indicated in signature 550 show matches to guideway 536 at locations 554 and 556.

In the signature-based scenario depicted in FIG. 5, the train never satisfies the confirmation requirement on the sensor-derived position measurement. But it does satisfy a confirmation requirement based on the heading measurement of the onboard location determining unit. In some embodiments, the requirements for the signature analysis are done a priori and stored in the guideway database, or they can be determined in real-time by a signature analysis algorithm. Either approach is within the capabilities of those skilled in the art.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method for confirming a location of a vehicle on a guideway upon awakening, wherein the method comprises:
determining initial location of the vehicle via on-board sensor systems;
analyzing an operational guideway database to determine whether a unique guideway path lies within a confidence threshold established for confirmation of the initial location, wherein,
(a) when a unique guideway path lies within the confidence threshold, consider the initial location as vitally confirmed; and
(b) when a unique guideway path does not lie within the confidence threshold, do not consider the initial location to be vitally confirmed.

2. The method of claim 1 and further wherein when a unique guideway path does not lie within the confidence threshold:
(i) develop a signature relating to movement of the vehicle; and
(ii) compare the signature to information to the operational guideway database to information contained in the operation guideway database to find an operational guideway that matches the signature.

3. The method of claim 2 wherein when a match is found, consider vehicle location to be confirmed.

4. The method of claim 2 wherein the signature is based on a trajectory of the vehicle.

5. The method of claim 2 wherein the signature is based on a heading rate.

6. The method of claim 2 wherein the signature is based on curvature.

7. The method of claim 1 wherein when a unique guideway path does not lie within the confidence threshold, permit the vehicle to proceed under less than full authority.
